(19) United States
(12) Patent Application Publication
(10) Pub. No.: US 2022/0122022 A1
(43) Pub. Date: Apr. 21, 2022

(54) METHOD OF PROCESSING DATA, DEVICE AND COMPUTER-READABLE STORAGE MEDIUM

(71) Applicant: Beijing Baidu Netcom Science Technology Co., Ltd., Beijing (CN)

(72) Inventors: Kaichun YAO, Beijing (CN); Jingshuai ZHANG, Beijing (CN); Hengshu ZHU, Beijing (CN); Chuan QIN, Beijing (CN); Chao MA, Beijing (CN); Peng WANG, Beijing (CN)

(21) Appl. No.: 17/564,372

(22) Filed: Dec. 29, 2021

(30) Foreign Application Priority Data
Mar. 31, 2021 (CN) 202110349452.0

(51) Int. Cl. G06Q 10/06; G06Q 10/10

(52) U.S. Cl. CPC G06Q 10/063112; G06Q 10/1053

(57) ABSTRACT

The present disclosure provides a method of processing data, a device and a computer-readable storage medium, which relates to a technical field of artificial intelligence, and in particular to fields of intelligent search and deep learning. The method includes: generating a resume heterogeneous graph and a job heterogeneous graph; determining a first matching feature representation for the resume and the job profile based on first and second node feature representations for a first node in the resume heterogeneous graph and a second node in the job heterogeneous graph respectively; determining a second matching feature representation for the resume and the job profile based on first and second graph feature representations for the resume heterogeneous graph and the job heterogeneous graph respectively; and determining a similarity between the resume and the job profile based on the first and second matching feature representations.

### CROSS-REFERENCE TO RELATED APPLICATIONS

This application is claims priority to Chinese Application No. 202110349452.0 filed on Mar. 31, 2021, which is incorporated herein by reference in its entirety.

### TECHNICAL FIELD

The present disclosure relates to a technical field of artificial intelligence, in particular to a method of processing data, a device and a computer-readable storage medium in fields of intelligent search and deep learning.

### BACKGROUND

With a development of society, companies provide more and more jobs of various types. While the various types of jobs are provided, requirements for jobs are also refined. In addition, with an improvement of an education level, a quantity of talents is also increasing rapidly.

A continuous development of online recruitment platforms greatly facilitates a recruitment of companies and a job hunting of candidates. In general, a large number of resumes may be delivered when a company releases a job demand through a recruitment platform. If a suitable talent is engaged, a rapid development of the company may be accelerated. Therefore, it is necessary to help the company find a talent matching a job profile from a large number of resumes, so as to speed up the development of the company. However, a lot of technical problems need to be solved in a process of providing a talent for the company by using a resume and a job profile.

### SUMMARY

The present disclosure provides a method of processing data, a device and a computer-readable storage medium.

According to an aspect, there is provided a method of processing data, including: generating, based on a resume and a job profile which are acquired, a resume heterogeneous graph for the resume and a job heterogeneous graph for the job profile, wherein the resume heterogeneous graph and the job heterogeneous graph include different types of nodes; determining a first matching feature representation for the resume and the job profile based on a first node feature representation for a first node in the resume heterogeneous graph and a second node feature representation for a second node in the job heterogeneous graph; determining a second matching feature representation for the resume and the job profile based on a first graph feature representation for the resume heterogeneous graph and a second graph feature representation for the job heterogeneous graph; and determining a similarity between the resume and the job profile based on the first matching feature representation and the second matching feature representation.

According to another aspect there is provided an electronic device, including: at least one processor; and a memory communicatively connected to the at least one processor, wherein the memory stores instructions executable by the at least one processor, and the instructions, when executed by the at least one processor, cause the at least one processor to implement the method described according to the first aspect of the present disclosure.

According to another aspect, there is provided a non-transitory computer-readable storage medium having computer instructions stored thereon, wherein the computer instructions are configured to cause a computer to implement the method described according to the first aspect of the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The drawings are used to understand the solution better and do not constitute a limitation to the present disclosure.

FIG. 1 shows a schematic diagram of an environment 100 in which various embodiments of the present disclosure may be implemented.

FIG. 2 shows a flowchart of a method 200 of processing data according to some embodiments of the present disclosure.

FIG. 3 shows a flowchart of a process 300 of determining a node feature representation and a graph feature representation of a heterogeneous graph according to some embodiments of the present disclosure.

FIG. 4 shows a flowchart of a process 400 of determining a similarity according to some embodiments of the present disclosure.

FIG. 5 shows a block diagram of an apparatus 500 of processing data according to some embodiments of the present disclosure.

FIG. 6 shows a block diagram of a device 600 for implementing various embodiments of the present disclosure.

### DETAILED DESCRIPTION OF EMBODIMENTS

Exemplary embodiments of the present disclosure are described below with reference to the drawings, which include various details of the embodiments of the present disclosure to facilitate understanding, and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

In the description of the embodiments of the present disclosure, the term “including” and similar terms should be understood as open-ended inclusion, that is, “including but not limited to”. The term “based on” should be understood as “at least partially based on.” The term “an embodiment,” “one embodiment” or “this embodiment” should be understood as “at least one embodiment.” The terms “first,” “second,” and the like may refer to different or the same object. The following may also include other explicit and implicit definitions.

It is necessary for a recruiter to select a resume. However, an evaluation for a quality of the resume not only requires a domain expertise, but also faces a problem of a large number of resumes, which may bring a great difficulty and challenge to a work of the recruiter.

A method of acquiring a resume corresponding to a job profile is a manual selection, in which whether a candidate's resume matches a published job demand or not is determined manually. However, the manual selection cannot deal with a large amount of data. Furthermore, since a person cannot have professional knowledge in various fields, a quality and an efficiency of selecting the resume may not be ensured.

Another scheme is an automatic person-job matching. In this scheme, the candidate's resume and the published job profile are regarded as two texts, and then a text matching is performed to calculate a similarity between the two texts so as to evaluate whether the candidate matches the job or not. However, the automatic person-job matching scheme fails to introduce an external prior knowledge, and it is difficult to eliminate a semantic gap between the resume and the job demand text by directly matching the two. Therefore, an accuracy may not be ensured. In addition, modeling the person-job matching as a text matching problem may results in a poor interpretability.

An improved scheme of processing data is proposed according to some embodiments of the present disclosure. In this scheme, a computing device may generate, based on a resume and a job profile which are acquired, a resume heterogeneous graph for the resume and a job heterogeneous graph for the job profile. Then, the computing device may determine a first matching feature representation for the resume and the job profile based on a first node feature representation for a first node in the resume heterogeneous graph and a second node feature representation for a second node in the job heterogeneous graph. The computing device may further determine a second matching feature representation for the resume and the job profile based on a first graph feature representation for the resume heterogeneous graph and a second graph feature representation for the job heterogeneous graph. The computing device may determine a similarity between the resume and the job profile based on the first matching feature representation and the second matching feature representation. With this method, a time required for matching the resume with the job profile may be reduced, and an accuracy of matching the resume with the job profile may be improved, so that a user experience may be improved.

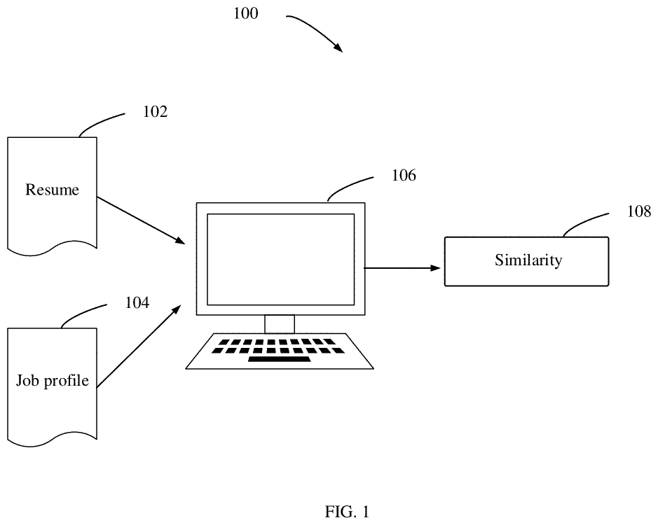

FIG. 1 shows a schematic diagram of an environment 100 in which various embodiments of the present disclosure may be implemented. The environment 100 may include a computing device 106.

The computing device 106 is used to match a resume 102 and a job profile 104 so as to determine a similarity 108 between the job profile and the resume. The exemplary computing device 106 includes, but is not limited to a personal computer, a server computer, a handheld or laptop device, a mobile device (such as a mobile phone, a personal digital assistant (PDA), a media player), a multiprocessor system, a consumer electronic product, a small computer, a large computer, a distributed computing environment including any one of the above systems or devices, and so on. The server may be a cloud server, also known as a cloud computing server or a cloud host, which is a host product in a cloud computing service system to solve defects of difficult management and weak business scalability existing in a traditional physical host and a VPS (Virtual Private Server) service. The server may also be a server of a distributed system or a server combined with a blockchain.

The resume 102 at least describes a skill that a candidate possesses. For example, a candidate in a field of a computer application possesses a skill of Java programming, a candidate in a field of a data management possesses a skill of using an SQL database, and so on. The above examples are only used to describe the present disclosure, not to specifically limit the present disclosure. Those skilled in the art may determine a job and a skill required by the job according to needs.

The job profile 104 at least describes a job released by the company and a skill required by the job. For example, the job released is a computer application engineer, and the skill required by the job is the Java programming skill. The above examples are only used to describe the present disclosure, not to specifically limit the present disclosure. Those skilled in the art may determine the job and the skill required by the job according to needs.

The computing device 106 may match the resume 102 received and the job profile 104 so as to determine the similarity 108 between the resume and the job profile, which may provide a reference for the company to select an appropriate person.

With this method, the time required for matching the resume with the job profile may be reduced, and the accuracy of matching the resume with the job profile may be improved, so that the user experience may be improved.

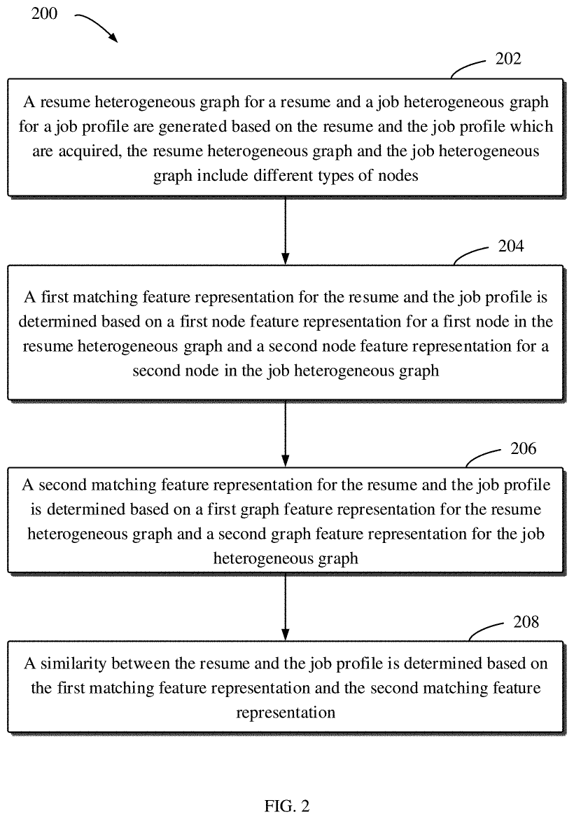

The schematic diagram of the environment 100 in which various embodiments of the present disclosure may be implemented is shown in FIG. 1. A flowchart of a method 200 of processing data according to some embodiments of the present disclosure will be described below with reference to FIG. 2. The method 200 in FIG. 2 is performed by the computing device 106 in FIG. 1 or any suitable computing device.

In block 202, a resume heterogeneous graph for a resume and a job heterogeneous graph for a job profile are generated based on the resume and the job profile which are acquired. The resume heterogeneous graph and the job heterogeneous graph may include different types of nodes. For example, the computing device 106 may firstly acquire the resume 102 and the job profile 104. Then, the computing device 106 generates the resume heterogeneous graph from the resume 102 and the job heterogeneous graph from the job profile 104.

In the present disclosure, a heterogeneous graph is a graph including different types of nodes and/or different types of edges. Both the job heterogeneous graph and the resume heterogeneous graph include at least two types of nodes, including a word node and a skill entity node, and further at least include two types of edges of three types of edges including a word-word edge, a word-skill entity edge, and a skill entity-skill entity edge.

In some embodiments, the computing device 106 may acquire the word and the skill entity from the resume 102. In an example, the computing device 106 may identify each word in the resume 102, and the computing device may further identify the skill entity from the resume 102. For example, a phrase identified may be compared with a skill entity in a skill entity list so as to determine the skill entity contained in the resume. The computing device may further acquire an associated skill entity related to the skill entity from a skill knowledge graph. The skill knowledge graph may include an association relationship between various skill entities determined according to existing knowledge. Then the computing device may generate a resume heterogeneous graph by using the word acquired, the skill entity acquired and the associated skill entity acquired as nodes. In this way, the resume heterogeneous graph may be generated quickly and accurately. Similarly, the job heterogeneous graph may be obtained in the same way.

In some embodiments, the resume heterogeneous graph or the job heterogeneous graph includes an edge of a word-word type. When determining this type of edge, the computing device 106 may determine that there is an association relationship between words in a window with a predetermined size, by swiping in the resume or the job profile in the window, that is, determines that there is the edge of the word-word type between the words in the window. The computing device may determine a word-skill entity type of edge between the skill entity and the related word by using the word contained in the skill entity. The computing device may further add an external skill entity related to the skill entity in the resume or the job profile into the heterogeneous map by using the skill knowledge graph. A skill entity-skill entity type of edge is formed between skill entities with an associated relationship. By introducing the external skill entity, a more accurate matching result may be obtained.

In some embodiments, the computing device 106 may acquire the word and the skill entity from the resume 102 and determine a relationship between the skill entities identified. Then the resume heterogeneous graph or the job profile heterogeneous graph may be generated by using the word and the skill entity. The above examples are only used to describe the present disclosure, not to specifically limit the present disclosure.

In block 204, a first matching feature representation for the resume and the job profile is determined based on a first node feature representation for a first node in the resume heterogeneous graph and a second node feature representation for a second node in the job heterogeneous graph. For example, the computing device 106 may determine the first matching feature representation for the resume and the job profile by using a node feature representation of a node in the resume heterogeneous graph and a node feature representation of a node in the job heterogeneous graph.

The computing device 106 needs to acquire the first node feature representation and the second node feature representation. In this way, the first matching feature representation for the resume and the job profile may be determined quickly and accurately. In an example, the feature representation of the node in the resume heterogeneous graph and the feature representation of the node in the job heterogeneous graph are vectors including a predetermined number of elements. In an example, the vector is a 50-dimensional vector. In another example, the vector is an 80-dimensional vector. The above examples are only used to describe the present disclosure, not to specifically limit the present disclosure.

The node feature representation of the node in the resume heterogeneous graph or the node feature representation of the node in the job heterogeneous graph is determined by a node feature representation of another node connected to the node. In some embodiments, when determining the node feature representation of the node in the resume heterogeneous graph, the computing device may firstly determine an adjacent node of the node and an edge between the node and the adjacent node. For the convenience of description, the node is called a first node. The computing device may then divide the adjacent node and the edge into a group of sub-graphs based on the type of the edge. Since the resume heterogeneous graph includes different types of edges, each sub-graph includes the first node, the same type of edge, and the adjacent node connected by the same type of edge. Then, the computing device may determine a feature representation of the first node for the sub-graph based on a feature representation of the adjacent node in the sub-graph. After the feature representation of the first node for the sub-graph is determined, the first node feature representation may be determined based on the feature representation of the first node for the sub-graph. In this way, the feature representation of the node in the heterogeneous graph may be determined quickly and accurately.

In some embodiments, when determining the feature representation of the first node for the sub-graph, the computing device 106 may determine an importance degree of the adjacent node in the sub-graph with respect to the first node. Then, the feature representation of the first node for the sub-graph may be determined based on the determined importance degree of the adjacent node and the feature representation of the adjacent node. In this way, the feature representation of the node in the sub-graph may be determined quickly and accurately.

In some embodiments, the computing device 106 may determine the feature representation of the node in each sub-graph through the following process. Given a sub-graph p∈P, P={W-W, W-S, S-S}, where W-W represents all the word-to-word sub-graphs, W-S represents all the word-to-skill-entity sub-graphs, and S-S represents all the skill-entity-to-skill-entity sub-graphs. In a sub-graph p, a neighborhood of node i is denoted as Nᵢ^{p}, and an initial feature representation of the node is denoted as a vector hᵢ. In an example, an initial vector of the node is a vector set by a user to uniquely represent the node. In another example, the initial vector of the node is a vector determined by word2vec for each word, and then a unique identification vector is determined for the skill entity. For each adjacent node j∈Nᵢ^{p} of the node i, an importance degree αᵢⱼ^{p} for node i and node j of the sub-graph p is calculated by Equation 1 to Equation 3, where i is a positive integer, and j is a positive integer.

$$\begin{matrix}{e}_{ij}^{p} = {att}_{p} ( {W}_{p} {h}_{i} , {W}_{p} {h}_{j} ) & Equation ( 1 ) \\ {att}_{p} = σ ( {V}_{p}^{T} [ {W}_{p} {h}_{i} \vert \vert {W}_{p} {h}_{j} ] ) & Equation ( 2 ) \\ {α}_{ij}^{p} = \frac{exp ( {e}_{ij}^{p} )}{{\sum }_{k ∈ {𝒩}_{i}^{p} exp ( {e}_{ik}^{p} )}} & Equation ( 3 )\end{matrix}$$

where hⱼ represents a node feature representation of a j-th node; eᵢⱼ^{p} represents a non-normalized importance degree between the node i and the node j in the sub-graph p, attₚ( ) represents a function of determining the non-normalized importance degree for the sub-graph p, σ( ) is LeakyReLU activation function; Wₚ and Vₚ represent learning parameters for the sub-graph p, which is a transformation matrix preset by the user, Vₚ^{T} represents a transposed learning parameter Vₚ, ∥ represents a splicing symbol of two vectors, and exp( ) is an exponential function. After αᵢⱼ^{p} is obtained, the feature representation hᵢ^{p} of the node i in the sub-graph p may be updated by Equation (4).

$${h}_{i}^{p} = σ ( {\sum }_{j ∈ {𝒩}_{i}^{p}} {α}_{i , j}^{p} {W}_{p} {h}_{j} ) \qquad Equation ( 4 )$$

where σ( ) is the LeakyReLU activation function, Wₚ represents a learning parameter for the sub-graph p, which is the transformation matrix preset by the user, and hⱼ represents the node feature representation of the j-th node.

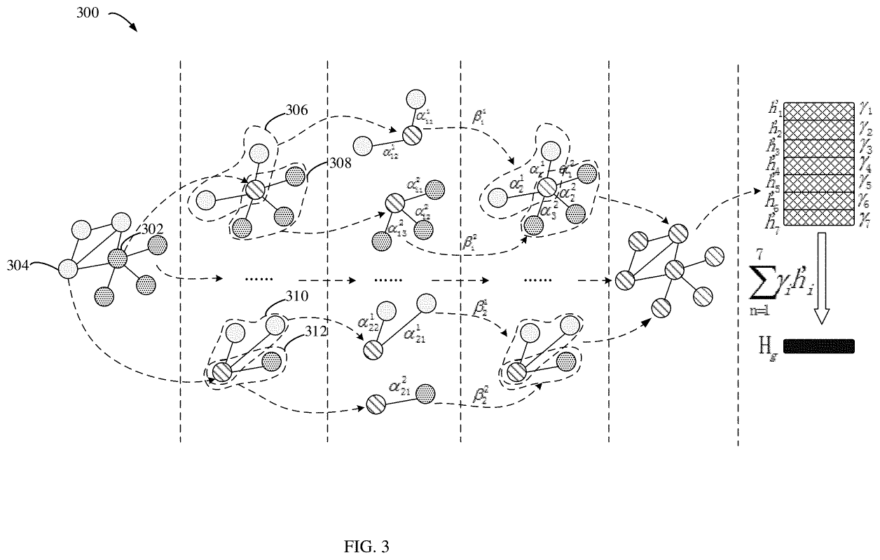

This process will be further described below in connection with FIG. 3. FIG. 3 shows a flowchart of a process 300 of determining a node feature representation and a graph feature representation of a heterogeneous graph according to some embodiments of the present disclosure. In FIG. 3, the heterogeneous graph includes a plurality of nodes and corresponding edges, as shown in a leftmost column in FIG. 3. The plurality of nodes include a node 302 and a node 304. The node 302 and the node 304 are different types of nodes. For example, one is a word node, and the other is a skill entity node. Adjacent nodes and corresponding edges of the node 302 and the node 304 may be determined from the heterogeneous graph. Then, the adjacent nodes and the corresponding edges of the node 302 may be divided into different sub-graphs based on the type of the edge. For example, the node 302 and the adjacent nodes of the node 302 are divided into a sub-graph 306 and a sub-graph 308. The node 304 and the adjacent nodes of the node 304 are divided into a sub-graph 310 and a sub-graph 312. The node 302 and the sub-graph including the node 302 are illustrated below to further introduce the node feature representation of the node 302, and other nodes are determined in the same way.

As shown in a third column of FIG. 3, it is determined that the importance degrees of the two nodes adjacent to the node 302 in the sub-graph 306 with respect to the node 302 are α₁₁¹ and α₁₂¹, respectively. Then the two importance degrees may be combined with the node feature representations of the two adjacent nodes to calculate the feature representation of the node 302 in the sub-graph 306 by using Equation (4). Similarly, the node representation of the node 302 in the sub-graph 308 may be calculated.

Referring back to FIG. 2, when determining the node feature representation, in addition to considering an influence of each adjacent node, it is also needed to determine an influence of each sub-graph on the node feature. In some embodiments, when determining the node feature representation of the first node with respect to the entire heterogeneous graph, the computing device 106 needs to determine the importance degree of each sub-graph including the first node with respect to the first node. Then, the importance degree and the feature representation of the first node for the sub-graph are used to determine the first node feature representation. In this way, the node feature representation of the node with respect to the entire heterogeneous graph may be determined quickly and accurately.

In some embodiments, after obtaining the node feature representation hᵢ^{p} of the node i in the heterogeneous graph under the sub-graph p, the computing device 106 may calculate an importance degree βᵢ^{p} of the sub-graph p with respect to the node i by Equation (5).

$$\begin{matrix}{e}_{i}^{p} = σ ( {U}_{p}^{T} [ {W}_{p} {h}_{i}^{p} \vert \vert {W}_{p} {h}_{i}^{k} ] ) , & Equation ( 5 ) \\ {β}_{i}^{p} = \frac{exp ( {e}_{i}^{p} )}{{\sum }_{k ∈ P} exp ( {e}_{i}^{k} )} & \end{matrix}$$

where hᵢ^{k} represents a feature representation of the node i obtained in a sub-graph k, eᵢ^{p} represents an importance degree of a non-normalized sub-graph p with respect to the node i, σ( ) is the LeakyReLU activation function; Uₚ represents a learning parameter, Uₚ^{T} is a transposed Uₚ; k represents a specified sub-graph, i.e., k∈P. Then, the node feature representation hᵢ′ of the node i determined by different sub-graphs may be updated by Equation (6).

$${h}_{i}^{′} = σ ( {\sum }_{k ∈ P} {β}_{i}^{p} {h}_{i}^{i} ) \qquad Equation ( 6 )$$

where σ( ) is the LeakyReLU activation function.

As shown in FIG. 3, after the importance degrees β₁¹ and β₁² of the sub-graph 306 and the sub-graph 308 with respect to the node are determined, the feature representation of the node may be determined.

Referring back to FIG. 2, after the feature representation of each node is acquired, the graph feature representation of the heterogeneous graph may be determined. Firstly, a global context feature representation C is calculated by Equation (7).

$$C = tanh ( ( \frac{1}{N} {\sum }_{n = 1}^{N} {h}_{i}^{′} ) {W}_{g} ) \qquad Equation ( 7 )$$

where W_{g} represents a learning parameter set by the user, N represents a number of all nodes in the heterogeneous graph, and tanh( ) is a hyperbolic tangent function. Then, an importance degree γᵢ of a given node feature representation hᵢ′ with respect to the global context feature representation C is calculated by Equation (8).

$${γ}_{i} sigmoid ( {h}_{i}^{T} C ) \qquad Equation ( 8 )$$

where hᵢ^{T} is a transpose of hᵢ′. Then, the feature representation H_{g} of the entire graph is obtained using the importance degrees of all node features and the node feature representations of all node features by using Equation (9).

$${H}_{g} = {\sum }_{n = 1}^{N} {γ}_{i} {h}_{i}^{′} \qquad Equation ( 9 )$$

As shown in FIG. 3, the graph feature representation H_{g} of the heterogeneous graph is calculated using the determined seven importance degrees γ₁-γ₇ and node feature representations h₁′-h₁′.

In some embodiments, in order to calculate the matching degree of the resume heterogeneous graph and the job heterogeneous graph, it is needed to calculate the matching degree of the resume heterogeneous graph and the job heterogeneous graph from a node level. The computing device 106 may calculate a feature representation of a similarity between the first node and the second node by using the first node feature representation of the first node in the resume heterogeneous graph and the second node feature representation of the second node in the job heterogeneous graph. Then, the computing device 106 may apply the feature representation of the similarity to a first neural network model so as to obtain the first matching feature representation. In this way, the first matching feature representation may be determined accurately and quickly.

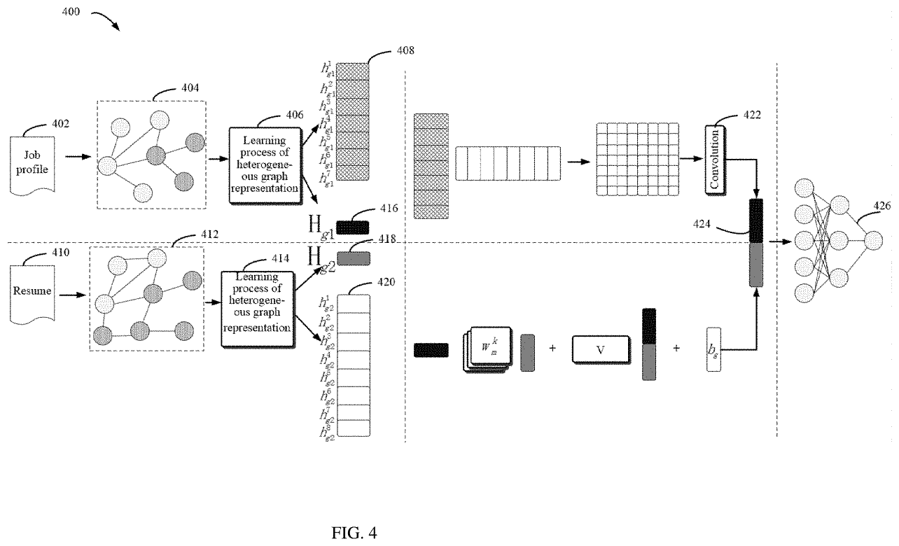

In some embodiments, the computing device 106 may further calculate a node-level matching. The node-level matching is used to learn a matching relationship between various nodes two heterogeneous graphs. Firstly, a matching matrix M∈ [symbol] ^{m×n} is used to model the feature matching between nodes, and a similarity between node i and node j is calculated by Equation (10).

$${M}_{i , j} = {h}_{g 1}^{i} {W}_{n} {h}_{g 2}^{j} \qquad Equation ( 10 )$$

where Wₙ∈ [symbol] ^{D×D} represents a parameter matrix, D represents a dimension of a node vector, R represents a value; [symbol] ^{D×D} represents a value space of D dimension×D dimension, h_{g1}ⁱ represents a node feature representation of the node i in a graph g₁, and h_{g2}^{j} represents a node feature representation of the node j in a graph g₂. M is a m×n matrix, which may be regarded as a two-dimensional picture format. Therefore, as shown in Equation (11) below, a hierarchical convolutional neural network is used to capture a matching feature representation under a node-level

$${Q}_{g 1 , g 2} = ConvNet ( M ; θ ) \qquad Equation ( 11 )$$

where [symbol] _{g1,g2} represents a feature representation learned from a node-level interaction; θ represents a parameter of the entire hierarchical convolutional neural network, and CnuvNet( ) represents the convolutional neural network. A process of calculating the matching feature representation may be described with reference to FIG. 4. FIG. 4 shows a flowchart of a process 400 of determining a similarity according to some embodiments of the present disclosure.

As shown in FIG. 4, a job heterogeneous graph 404 and a resume heterogeneous graph 412 are firstly determined from a job profile 402 and a resume 410. Then, node feature representations 408 and 420 for the nodes of each heterogeneous graph and graph feature representations 416 and 418 for the graph may be obtained by using heterogeneous graph representation learning processes 406 and 414 shown in FIG. 3. Then, as illustrated on an upper side of a middle column of FIG. 4, a process of determining the first matching feature representation is shown.

Now referring back to FIG. 2, in block 206, the second matching feature representation for the resume and the job profile is determined based on a first graph feature representation for the resume heterogeneous graph and a second graph feature representation for the job heterogeneous graph. For example, the computing device 106 may determine the second matching feature representation for the resume and the job profile by using the graph feature representation of the resume heterogeneous graph and the graph feature representation of the job heterogeneous graph.

In some embodiments, the computing device may generate the graph feature representation of the resume heterogeneous graph or the graph feature representation of the job heterogeneous graph by using the calculated node feature representation of each node in the heterogeneous graph.

In some embodiments, the computing device 106 may perform a graph-level matching. In the graph-level matching, a matching feature representation between graph representations H_{g1} and H_{g2} of two heterogeneous graphs is modeled directly by using Equation (12).

$$g ( {H}_{g 1} , {H}_{g 2} ) = σ ( {H}_{g 1} {W}_{m}^{[ 1 : K ]} {H}_{g 2} + V [ \begin{matrix}{H}_{g 1} \\ {H}_{g 2}\end{matrix} ] ] + {b}_{g} ) \qquad Equation ( 12 )$$

where σ(⋅) is the LeakyReLU activation function, Wₘ^{[1:K]}∈ [symbol] ^{D×D×K} is a transformation matrix set by the user, D represents a dimension of a node vector, R represents a value, K represents a super parameter set by the user, such as 8 or 16, which is used to control the number of interactive relationships between the two graphs, and V∈ [symbol] ^{K×D} and b_{g}∈ [symbol] ^{D} represent learning parameters set by the user; [ ] represents a splicing symbol of two vectors. The second matching feature representation is determined as shown on a lower side of the middle column in FIG. 4.

In block 208, a similarity between the resume and the job profile is determined based on the first matching feature representation and the second matching feature representation.

In some embodiments, the computing device 106 may combine the first matching feature representation and the second matching feature representation so as to obtain a combined feature representation. Then, the computing device 106 may apply the combined feature representation to a second neural network model so as to obtain a score for the similarity.

After learning the first matching feature representation and the second matching feature representation from the graph level and the node level, g(H_{g1},H_{g2}) and [symbol] _{g1,g2} are stitched, and the score s_{g1,g2} for the similarity between the two graphs g1 and g2 are predicted through a two-layer feedforward fully connected neural network and a nonlinear transformation using sigmoid activation function.

When training the model, the score s_{g1,g2} for the similarity is compared with a score [symbol] _{g1,g2} for a real similarity between samples, and finally the entire model parameter is updated by using a mean square loss function obtained by Equation (13).

$$ℒ = \frac{1}{\vert 𝒟 \vert} {\sum }_{( {g}_{1}^{i} : {g}_{2}^{j} ) ∈ 𝒟} {( {s}_{{g}_{1}^{i} , {g}_{2}^{j}} - {y}_{{g}_{1}^{i} , {g}_{2}^{j}} )}^{2} \qquad Equation ( 13 )$$

where D represents the entire set of matching training samples, g₁ⁱ represents the i-th node of the graph g₁, and g₂^{j} represents the j-th node of the graph g₂.

With this method, the time required for matching the resume with the job profile may be reduced, and the accuracy of matching the resume with the job profile may be improved, so that the user experience may be improved.

FIG. 5 shows a schematic block diagram of an apparatus 500 of processing data according to some embodiments of the present disclosure. As shown in FIG. 5, the apparatus 500 includes a heterogeneous graph generation module 502 used to generate, based on a resume and a job profile which are acquired, a resume heterogeneous graph for the resume and a job heterogeneous graph for the job profile. The resume heterogeneous graph and the job heterogeneous graph include different types of nodes. The apparatus 500 further includes a first matching feature representation module 504 used to determine a first matching feature representation for the resume and the job profile based on a first node feature representation for a first node in the resume heterogeneous graph and a second node feature representation for a second node in the job heterogeneous graph. The apparatus 500 further includes a second matching feature representation module 506 used to determine a second matching feature representation for the resume and the job profile based on a first graph feature representation for the resume heterogeneous graph and a second graph feature representation for the job heterogeneous graph. The apparatus 500 further includes a similarity determination module 508 used to determine a similarity between the resume and the job profile based on the first matching feature representation and the second matching feature representation.

In some embodiments, the heterogeneous graph generation module 502 includes an entity acquisition module used to acquire a word and a skill entity from the resume; an associated skill entity acquisition module used to acquire an associated skill entity related to the skill entity from a skill knowledge graph; and a resume heterogeneous graph generation module used to generate the resume heterogeneous graph by using the word, the skill entity and the associated skill entity as nodes.

In some embodiments, the first matching feature representation module 504 includes a similarity feature representation determination module used to determine a feature representation of the similarity between the first node and the second node based on the first node feature representation and the second node feature representation; and an application module used to apply the feature representation of the similarity to a first neural network model so as to obtain the first matching feature representation.

In some embodiments, the similarity determination module 508 includes a combined feature representation module used to combine the first matching feature representation and the second matching feature representation so as to obtain a combined feature representation; and a similarity score acquisition module used to apply the combined feature representation to a second neural network model so as to obtain a score for the similarity.

In some embodiments, the apparatus 500 further includes a node feature representation acquisition module used to acquire the first node feature representation and the second node feature representation.

In some embodiments, the node feature representation acquisition module includes: an edge determination module used to determine an adjacent node of the first node and an edge between the first node and the adjacent node; a sub-graph determination module used to divide the adjacent node and the edge into a group of sub-graphs based on a type of the edge, wherein the resume heterogeneous graph includes a plurality of types of edges, and a sub-graph in the group of sub-graphs includes the first node and an adjacent node corresponding to a type of edge; a first feature representation determination module used to determine a feature representation of the first node for the sub-graph based on a feature representation of the adjacent node in the sub-graph; and a first node feature representation determination module used to determine the first node feature representation based on the feature representation of the first node for the sub-graph.

In some embodiments, the first feature representation determination module includes: a first importance degree determination module used to determine a first importance degree of the adjacent node in the sub-graph with respect to the first node; and a second feature representation determination module used to determine the feature representation of the first node for the sub-graph based on the first importance degree and the feature representation of the adjacent node.

In some embodiments, the first node feature representation determination module includes: a second importance degree determination sub-module used to determine a second importance degree of the sub-graph with respect to the first node; and a first node feature representation determination sub-module used to determine the first node feature representation based on the second importance degree and the feature representation of the first node for the sub-graph.

Collecting, storing, using, processing, transmitting, providing, and disclosing etc. of the personal information of the user involved in the present disclosure all comply with the relevant laws and regulations, and do not violate the public order and morals.

According to the embodiments of the present disclosure, the present disclosure further provides an electronic device, a readable storage medium, and a computer program product.

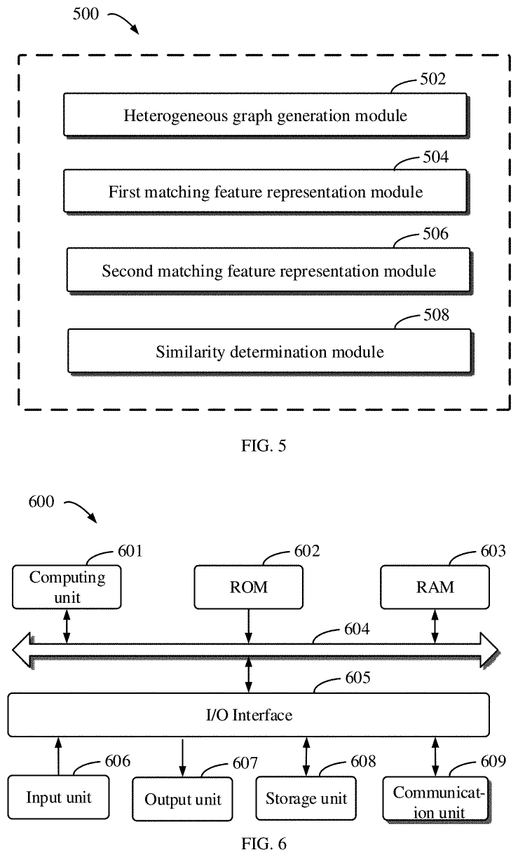

FIG. 6 shows a schematic block diagram of an exemplary electronic device 600 for implementing the embodiments of the present disclosure. The exemplary electronic device 600 may be used to implement the computing device 106 in FIG. 1. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601, which may perform various appropriate actions and processing based on a computer program stored in a read-only memory (ROM) 602 or a computer program loaded from a storage unit 608 into a random access memory (RAM) 603. Various programs and data required for the operation of the electronic device 600 may be stored in the RAM 603. The computing unit 601, the ROM 602 and the RAM 603 are connected to each other through a bus 604. An input/output (I/O) interface 605 is also connected to the bus 604.

Various components in the electronic device 600, including an input unit 606 such as a keyboard, a mouse, etc., an output unit 607 such as various types of displays, speakers, etc., a storage unit 608 such as a magnetic disk, an optical disk, etc., and a communication unit 609 such as a network card, a modem, a wireless communication transceiver, etc., are connected to the I/O interface 605. The communication unit 609 allows the electronic device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 601 may perform the various methods and processes described above, such as the method 200 to the processes 300 and 400. For example, in some embodiments, the method 200 to the processes 300 and 400 may be implemented as a computer software program that is tangibly contained on a machine-readable medium, such as the storage unit 608. In some embodiments, part or all of a computer program may be loaded and/or installed on electronic device 600 via the ROM 602 and/or the communication unit 609. When the computer program is loaded into the RAM 603 and executed by the computing unit 601, one or more steps of the method 200 to the processes 300 and 400 described above may be performed. Alternatively, in other embodiments, the computing unit 601 may be configured to perform the method 200 to the processes 300 and 400 in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing data, comprising:
generating, based on a resume and a job profile which are acquired, a resume heterogeneous graph for the resume and a job heterogeneous graph for the job profile, wherein the resume heterogeneous graph and the job heterogeneous graph comprise different types of nodes;
determining a first matching feature representation for the resume and the job profile based on a first node feature representation for a first node in the resume heterogeneous graph and a second node feature representation for a second node in the job heterogeneous graph;
determining a second matching feature representation for the resume and the job profile based on a first graph feature representation for the resume heterogeneous graph and a second graph feature representation for the job heterogeneous graph; and
determining a similarity between the resume and the job profile based on the first matching feature representation and the second matching feature representation.

2. The method of claim 1, wherein the generating a resume heterogeneous graph comprises:
acquiring a word and a skill entity from the resume;
acquiring an associated skill entity related to the skill entity from a skill knowledge graph; and
generating the resume heterogeneous graph by using the word, the skill entity and the associated skill entity as nodes.

3. The method of claim 1, wherein the determining a first matching feature representation comprises:
determining a feature representation of a similarity between the first node and the second node based on the first node feature representation and the second node feature representation; and
applying the feature representation of the similarity to a first neural network model so as to obtain the first matching feature representation.

4. The method of claim 1, wherein the determining a similarity comprises:
combining the first matching feature representation and the second matching feature representation so as to obtain a combined feature representation; and
applying the combined feature representation to a second neural network model so as to obtain a score for the similarity.

5. The method of claim 1, further comprising:
acquiring the first node feature representation and the second node feature representation.

6. The method of claim 5, wherein the acquiring the first node feature representation comprises:
determining an adjacent node of the first node and an edge between the first node and the adjacent node;
dividing the adjacent node and the edge into a group of sub-graphs based on a type of the edge, wherein the resume heterogeneous graph comprises a plurality of types of edges, and a sub-graph in the group of sub-graphs comprises the first node and an adjacent node corresponding to a type of edge;
determining a feature representation of the first node for the sub-graph based on a feature representation of the adjacent node in the sub-graph; and
determining the first node feature representation based on the feature representation of the first node for the sub-graph.

7. The method of claim 6, wherein the determining a feature representation of the first node for the sub-graph comprises:
determining a first importance degree of the adjacent node in the sub-graph with respect to the first node; and
determining the feature representation of the first node for the sub-graph based on the first importance degree and the feature representation of the adjacent node.

8. The method of claim 6, wherein the determining the first node feature representation comprises:
determining a second importance degree of the sub-graph with respect to the first node; and
determining the first node feature representation based on the second importance degree and the feature representation of the first node for the sub-graph.

9. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

10. The electronic device of claim 9, wherein the at least one processor is further configured to:
acquire a word and a skill entity from the resume;
acquire an associated skill entity related to the skill entity from a skill knowledge graph; and
generate the resume heterogeneous graph by using the word, the skill entity and the associated skill entity as nodes.

11. The electronic device of claim 9, wherein the at least one processor is further configured to:
determine a feature representation of a similarity between the first node and the second node based on the first node feature representation and the second node feature representation; and
apply the feature representation of the similarity to a first neural network model so as to obtain the first matching feature representation.

12. The electronic device of claim 9, wherein the at least one processor is further configured to:
combine the first matching feature representation and the second matching feature representation so as to obtain a combined feature representation; and
apply the combined feature representation to a second neural network model so as to obtain a score for the similarity.

13. The electronic device of claim 9, wherein the at least one processor is further configured to:
acquire the first node feature representation and the second node feature representation.

14. The electronic device of claim 13, wherein the at least one processor is further configured to:
determine an adjacent node of the first node and an edge between the first node and the adjacent node;
divide the adjacent node and the edge into a group of sub-graphs based on a type of the edge, wherein the resume heterogeneous graph comprises a plurality of types of edges, and a sub-graph in the group of sub-graphs comprises the first node and an adjacent node corresponding to a type of edge;
determine a feature representation of the first node for the sub-graph based on a feature representation of the adjacent node in the sub-graph; and
determine the first node feature representation based on the feature representation of the first node for the sub-graph.

15. A non-transitory computer-readable storage medium having computer instructions stored thereon, wherein the computer instructions are configured to cause a computer to implement the method of claim 1.

16. The non-transitory computer-readable storage medium of claim 15, wherein the computer instructions are further configured to cause a computer to:
acquire a word and a skill entity from the resume;
acquire an associated skill entity related to the skill entity from a skill knowledge graph; and
generate the resume heterogeneous graph by using the word, the skill entity and the associated skill entity as nodes.

17. The non-transitory computer-readable storage medium of claim 15, wherein the computer instructions are further configured to cause a computer to:
determine a feature representation of a similarity between the first node and the second node based on the first node feature representation and the second node feature representation; and
apply the feature representation of the similarity to a first neural network model so as to obtain the first matching feature representation.

18. The non-transitory computer-readable storage medium of claim 15, wherein the computer instructions are further configured to cause a computer to:
combine the first matching feature representation and the second matching feature representation so as to obtain a combined feature representation; and
apply the combined feature representation to a second neural network model so as to obtain a score for the similarity.

19. The non-transitory computer-readable storage medium of claim 15, wherein the computer instructions are further configured to cause a computer to:
acquire the first node feature representation and the second node feature representation.

20. The non-transitory computer-readable storage medium of claim 19, wherein the computer instructions are further configured to cause a computer to:
determine an adjacent node of the first node and an edge between the first node and the adjacent node;
divide the adjacent node and the edge into a group of sub-graphs based on a type of the edge, wherein the resume heterogeneous graph comprises a plurality of types of edges, and a sub-graph in the group of sub-graphs comprises the first node and an adjacent node corresponding to a type of edge;
determine a feature representation of the first node for the sub-graph based on a feature representation of the adjacent node in the sub-graph; and
determine the first node feature representation based on the feature representation of the first node for the sub-graph.
